(19) United States
(12) Patent Application Publication
(10) Pub. No.: US 2025/0030484 A1
(43) Pub. Date: Jan. 23, 2025

(54) Optical Circuit Device, Integrated Optical Device And Method For Manufacturing Of Integrated Optical Device

(71) Applicant: Nippon Telegraph and Telephone Corporation, Tokyo (JP)

(72) Inventor: Yu Kurata, Musashino-shi, Tokyo (JP)

(21) Appl. No.: 18/714,001

(22) PCT Filed: Dec. 6, 2021
(86) PCT No.: PCT/JP2021/044780

§ 371 Date: May 28, 2024

(51) Int. Cl. H04B 10/54; G02B 6/124; G02B 6/125; G02B 6/26

(52) U.S. Cl. CPC H04B 10/541; G02B 6/124; G02B 6/125; G02B 6/26

(57) ABSTRACT

An integrated optical device includes: an optical amplifier that amplifies signal light input from the optical function element to the optical circuit element through a connection portion; and a connection tap port that is installed between the optical amplifier and the connection portion, branches a part of the signal light input from the optical function element through the connection portion, and outputs the signal light to the outside, and the connection tap port includes an input port that receives the signal light input from the optical function element to the optical circuit element through the connection portion, a demultiplexer that branches a part of the signal light, a first output port that outputs the branched part of the signal light to the outside, and a second output port that outputs a part of the branched signal light to the optical amplifier.

### TECHNICAL FIELD

The present disclosure relates to an optical circuit element, an integrated optical device in which an optical circuit element and an optical function element are directly connected, and a method for manufacturing an integrated optical device.

### BACKGROUND ART

In recent years, with the spread of optical fiber transmission, a technology of integrating a large number of optical circuits at high density has been required, and a quartz-based planar lightwave circuit (hereinafter referred to as a PLC) or an optical circuit using silicon photonics (Si-Photonics: hereinafter referred to as SiP) is known as a representative example of an optical circuit element applied as a platform thereof. A PLC is a waveguide type optical device having excellent characteristics such as low loss, high reliability, and a high degree of freedom in design, and a PLC in which functions such as a multiplexer/demultiplexer and a branching/coupling device are integrated is actually mounted in a transmission device at an optical communication transmission end. Meanwhile, a SiP device is an optical device that has a high degree of freedom in design and can realize a smaller optical circuit with a small waveguide bending radius although the SiP does not reach a PLC in terms of low loss. In addition to the PLC and SiP, an optical function element such as a Photo Diode (hereinafter referred to as a PD) that converts between light and electrical signals, a laser diode (hereinafter referred to as an LD), or an optical modulator is also mounted in the transmission device in optical fiber transmission. In such a transmission device, in order to further increase communication capacity, a highly functional integrated optical device in which an optical waveguide such as a PLC that performs optical signal processing and an optical device such as a PD that is made of an indium phosphide (InP)-based material and performs high-speed photoelectric conversion are integrated is required.

As described above, a PLC and a SiP device are promising as platforms for integrated optical devices, and integrated optical devices in which an InP optical modulator chip and a PLC chip are integrated in a hybrid have already been proposed (for example, refer to Non Patent Literature 1). The integrated optical device having such a form is configured such that, for example, a phase modulator is integrated on an InP chip, a polarization rotator and a polarization beam combiner are integrated on a PLC, and the respective chips are optically coupled via a lens. In the integrated optical device according to the conventional technology having such a form, since the PLC is used as the polarization Mux chip, there are advantages that a mounting area is small and optical axis alignment can be simplified as compared with a method of constructing conventional polarization synthesis by a spatial optical system.

Such a form in which the optical circuit element (for example, PLC) and the optical function element (for example, a PD or the like using an InP-based material) are combined and optically coupled is highly advantageous from the viewpoint of size reduction of the device and the degree of freedom in designing the optical circuit. Therefore, in order to expand the communication capacity, development of an integrated optical device such as a PD having a waveguide structure suitable for widening the bandwidth and an optical phase modulator having a high-speed phase modulation function has been advanced. However, in recent years, there has been an increasing demand for further size reduction, and in order to realize this, there is a strong demand for an integrated optical device in which an optical circuit element (for example, a PLC or the like) and an optical function element (for example, a PD or the like using an InP-based material) are directly connected without a lens.

It is important that such an integrated optical device in which an optical circuit element and an optical function element are directly connected is connected after alignment with high accuracy such that an optical loss does not occur at a connection portion. For example, when the optical fiber and the PLC abut against each other and are connected to each other, first, the end surface of the fiber block to which the optical fiber is fixed and the end surface of the PLC are adjusted to be parallel, and then the light output position from the optical fiber is adjusted to the input waveguide of the PLC. Then, position adjustment (alignment) is performed to obtain optimum optical coupling while monitoring the output from the output waveguide connected to the input waveguide. Thereafter, the interface of the connection portion is filled with a UV curing adhesive, the adhesive is cured by UV irradiation, and the optical fiber and the PLC are connected by adhesion. By such a procedure, an integrated optical device in which an optical circuit element and an optical function element are directly connected is produced. Then, unlike the integrated optical device according to the above-described conventional technology, the integrated optical device produced by such a method does not need to pass through a lens for optical coupling between the optical circuit element and the optical function element, and thus becomes a smaller-sized integrated optical device. However, in a combination of different materials such as PLC and InP or SiP and InP, since the refractive index and the waveguide shape are different, it is necessary to connect optical waveguides having greatly different mode fields of signal light.

FIG. 1 is a diagram conceptually showing a structure of an integrated optical device 10 according to the conventional technology in which an optical circuit element 11 and an optical function element 12 are directly connected. Here, as an example, the optical circuit element is a PLC used as a polarization Mux chip, and the optical function element is an InP-based chip that performs phase modulation. As shown in FIG. 1, the integrated optical device 10 includes the optical circuit element 11 serving as a platform to which signal light is input and output, and an optical function element 12 that performs signal modulation, amplification, and the like (here, phase modulation), and the optical circuit element 11 and the optical function element 12 are optically coupled by direct connection. Further, the optical circuit element 11 further includes a polarization rotator 13 that polarization-rotates a part of the signal light, and a polarization beam combiner 14 that multiplexes the signal light polarization-rotated by the polarization rotator 13 and the signal light not polarization-rotated, and the optical function element 12 further includes a phase modulator 15 that performs phase modulation of the input signal light.

In the integrated optical device 10 configured as described above, the optical circuit element 11 and the optical function element 12 are directly connected after being aligned not to cause optical loss. However, since both are different in refractive index and waveguide shape, a large optical loss may occur due to the mode field mismatch. As a technology for compensating for the optical loss caused by such a mode field mismatch, a technology is conventionally known in which a semiconductor optical amplifier (hereinafter referred to as an SOA) is mounted on an optical circuit element, and a coupling loss that can occur at a connection portion is compensated for by optical amplification.

FIG. 2 is a diagram conceptually showing a structure of an integrated optical device 20 that compensates for an optical loss due to a mode field mismatch at the connection portion according to the conventional technology. Similarly to FIG. 1, here, as an example, the optical circuit element is a PLC used as a polarization Mux chip, and the optical function element is an InP-based chip that performs phase modulation. In addition to the configuration of FIG. 1, the integrated optical device 20 further includes an optical amplifier 21 that amplifies signal light input from the optical function element 12 to the optical circuit element 11 through the connection portion.

As described above, the optical amplifier 21 performs optical amplification for compensating for an optical loss caused by the mode field mismatch at the connection portion, and for example, the above-described SOA can be applied. The integrated optical device having such a configuration is an integrated optical device in which an optical circuit element and an optical function element are directly connected to each other with optical loss due to the connection portion, but can maintain a high signal light output.

However, the optical amplifier installed on the optical circuit element becomes a loss medium in a case where the optical amplification operation is not performed due to current application, and thus, may become a factor in attenuation of the output light. As a result, it may be difficult to adjust the position by the optical output monitor in the above-described alignment in the direct connection. In addition, in a case where the optical amplifier is an SOA, in order to operate the SOA, it is necessary to probe the SOA chip or the electrode in order to apply a current, and in particular, when a plurality of SOAs are operated, the work becomes complicated. In order to solve such a problem, there is a measure of providing a through port in the vicinity of an input waveguide connected to the SOA and monitoring output light from the through port. However, this method does not perform alignment while monitoring optical coupling in a waveguide for signal light, and thus there is a problem that an optical loss occurs due to positional shift or the like at the time of sliding.

As described above, in the integration of the optical circuit element (for example, a PLC or a SiP) on which the optical amplifier (for example, an SOA) is mounted and the optical function element (for example, a phase modulator), it is necessary to realize an integrated optical device that enables highly accurate and simple connection between waveguides.

### CITATION LIST

### Non Patent Literature

Non Patent Literature 1: E. Yamada et al., “112-Gb/s InP DP-QPSK modulator integrated with a silica-PLC polarization multiplexing circuit”, Proc. Opt. Fiber Commun. Conf. Expo. Nat. Fiber Opt. Eng. Conf., March 2012

### SUMMARY OF INVENTION

### Technical Problem

The present disclosure has been made in view of the above problems, and an object thereof is to provide an integrated optical device that can easily produce connection of waveguides and realize highly accurate optical coupling in integration of an optical circuit element on which an optical amplifier is mounted and an optical function element such as an optical modulator.

### Solution to Problem

In order to solve the above problem, according to the present disclosure, there is provided an integrated optical device according to the present disclosure in which an optical circuit element and an optical function element are directly connected, the integrated optical device including: an optical amplifier that amplifies signal light input from the optical function element to the optical circuit element through a connection portion; and a connection tap port that is installed between the optical amplifier and the connection portion, branches a part of the signal light input from the optical function element through the connection portion, and outputs the signal light to the outside, in which the connection tap port includes an input port that receives the signal light input from the optical function element to the optical circuit element through the connection portion, a demultiplexer that branches a part of the signal light, a first output port that outputs the branched part of the signal light to the outside, and a second output port that outputs a part of the branched signal light to the optical amplifier.

### BRIEF DESCRIPTION OF DRAWINGS

FIG. 1 is a diagram conceptually showing a structure of an integrated optical device according to the conventional technology in which an optical circuit element and an optical function element are directly connected.

FIG. 2 is a diagram conceptually showing a structure of an integrated optical device that compensates for an optical loss due to a mode field mismatch at the connection portion according to the conventional technology.

FIG. 3 is a diagram conceptually showing a structure of an integrated optical device in which an optical circuit element and an optical function element are directly connected according to the present disclosure.

FIG. 4 is a flowchart showing a method for manufacturing an integrated optical device according to the present disclosure.

FIG. 5 is a diagram conceptually showing a structure of the integrated optical device in which the optical circuit element and the optical function element are directly connected according to the present disclosure.

### DESCRIPTION OF EMBODIMENTS

Various embodiments of the present disclosure will be described below in detail with reference to the drawings. The same or similar reference signs denote the same or similar components, and repetitive explanation thereof will be omitted in some cases. The following description is an example, and some configurations may be omitted, modified, or implemented together with additional configurations without departing from the gist of an embodiment of the present disclosure.

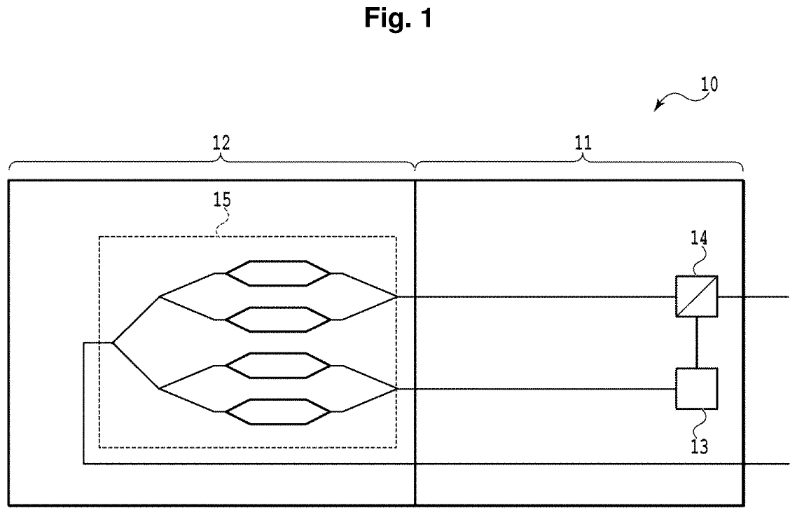

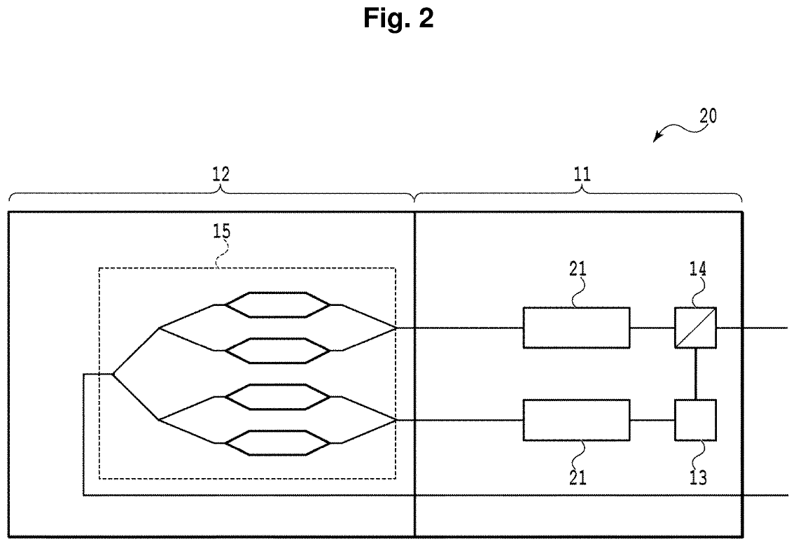

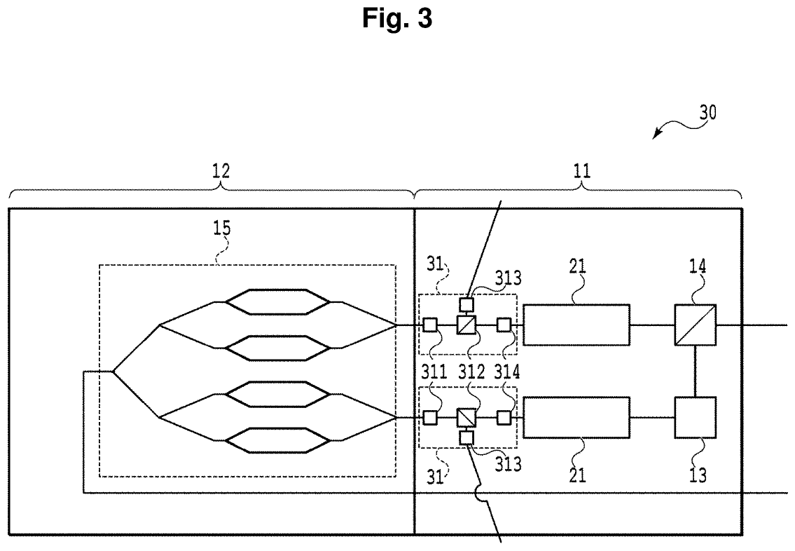

FIG. 3 is a diagram conceptually showing a structure of an integrated optical device 30 in which an optical circuit element 11 and an optical function element 12 are directly connected according to the present disclosure. Similarly to FIGS. 1 and 2, here, as an example, the optical circuit element is a PLC used as a polarization Mux chip, and the optical function element is an InP-based chip that performs phase modulation. Similarly to the integrated optical device 10 and the integrated optical device 20, the integrated optical device 30 according to the present disclosure includes the optical circuit element 11 serving as a platform to which signal light is input and output, and the optical function element 12 that performs signal modulation, amplification, and the like (here, phase modulation), and a waveguide formed in the optical circuit element 11 and a waveguide formed in the optical function element 12 are optically coupled by direct connection. Furthermore, the optical circuit element 11 further includes a polarization rotator 13 that polarization-rotates a part of the signal light, a polarization beam combiner 14 that multiplexes the signal light polarization-rotated by the polarization rotator 13 and the signal light not polarization-rotated, an optical amplifier 21 that is installed on a substrate using an InP-based material and performs optical amplification of the signal light input from the optical function element 12 to the optical circuit element 11 through the connection portion, and a connection tap port 31 that is installed between the connection portion and the optical amplifier 21 and outputs a part of the signal light input from the optical function element 12 to the optical circuit element 11 through the connection portion to the outside of the integrated optical device 30.

The connection tap port 31 includes an input port 311 through which the signal light from the optical function element 12 becomes incident through the connection portion, a demultiplexer 312 that branches a part of the input signal light, an output port 313 that emits a part of the branched signal light to the outside, and an output port 314 that emits a part of the branched signal light to the optical amplifier 21. The demultiplexer 312 may be, for example, a directional coupler, a Y-branch, a multimode interferometer, or a variable optical attenuator (hereinafter referred to as a VOA). In particular, the VOA has an advantage that the power of the signal light output from the integrated optical device 30 can be more finely controlled because the power of the signal light input to the optical amplifier 21 can be adjusted.

Furthermore, in the present disclosure, the optical circuit element 11 may be, for example, a PLC in which a waveguide is formed on a Si substrate. Furthermore, the optical amplifier 21 can be, for example, an SOA formed on a substrate to which an InP-based material is applied. The optical amplifier 21 is preferably fixed inside a groove provided such that each of the height of the waveguide of the optical circuit element 11 and the height of its own waveguide match each other.

In the integrated optical device 30 configured as described above according to the present disclosure, a part of the signal light output from the connection tap port 31 to the outside can be used for a monitor for alignment. As described above, the connection tap port 31 is configured to tap a part of the signal light before inputting the signal light into the optical amplifier 21. Therefore, it is not necessary to pass through the optical amplifier 21 in the output monitoring of the signal light for alignment. Therefore, since the above-described optical loss due to the optical amplifier 21 does not occur, it is possible to perform alignment with higher accuracy than in the conventional technology.

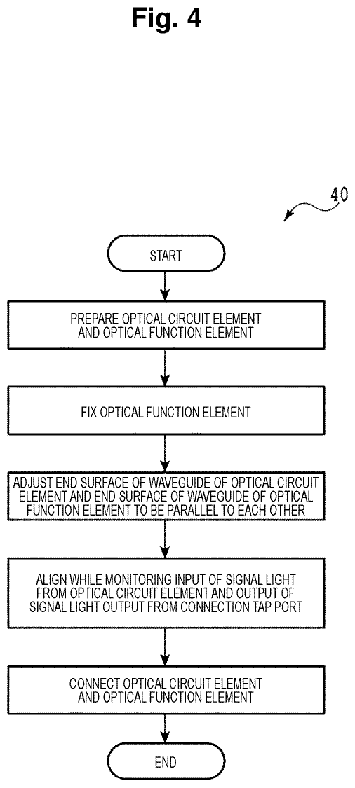

FIG. 4 is a flowchart showing a manufacturing method 40 of the integrated optical device 30 according to the present disclosure. The manufacturing method 40 of the integrated optical device 30 according to the present disclosure includes: preparing the optical circuit element 11 and the optical function element 12 (corresponding to step 41 in FIG. 4); fixing the optical function element 12 (corresponding to step 42 in FIG. 4); adjusting an end surface of a waveguide of the optical circuit element 11 and an end surface of a waveguide of the optical function element 12 to be parallel to each other (corresponding to step 43 in FIG. 4); aligning while monitoring the input of the signal light from the optical circuit element 11 and output of the signal light output from the connection tap port (corresponding to step 44 in FIG. 4); and connecting the optical circuit element 11 and the optical function element 12 (corresponding to step 45 in FIG. 4). The method of connecting the optical circuit element 11 and the optical function element 12 may be, for example, adhesion using a UV curable resin.

In the manufacturing method 40, since the output of the signal light output from the connection tap port is monitored in alignment between the optical circuit element 11 and the optical function element 12, it is not necessary to operate the optical amplifier 21. Therefore, it is not necessary to probe the optical amplifier 21 for alignment, and the work process of alignment can be simplified and shortened. In particular, this effect is large for an integrated optical device including a plurality of optical amplifiers.

Note that, in the integrated optical device 30 according to the present disclosure shown in FIG. 3, the signal light output from the output port 313 of the connection tap port 31 is depicted to be output to the side surface on the long side of the integrated optical device 30. However, in general, since a fixing jig or the like may be installed on the side surface of the integrated optical device, it may be difficult to connect a measuring instrument or an optical fiber for monitoring output light. In order to correspond to such a case, the integrated optical device according to the present disclosure may further include a mechanism that converts the optical path of the signal light output from the connection tap port 31 in a direction perpendicular to the substrate surface.

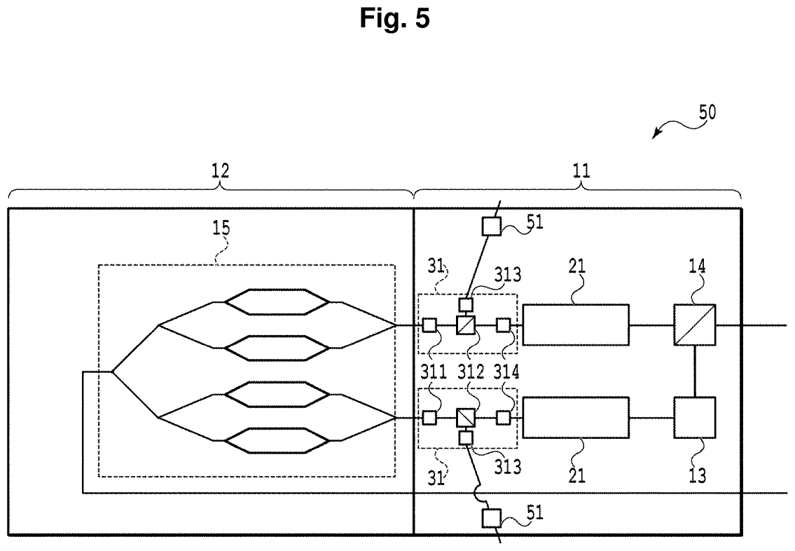

FIG. 5 is a diagram conceptually showing a structure of the integrated optical device 50 in which the optical circuit element 11 and the optical function element 12 are directly connected according to the present disclosure. The integrated optical device 50 further includes, on the optical circuit element 11 of the integrated optical device 30 described above, an optical path converter 51 that converts the optical path of the signal light branched from the connection tap port 31 and used for alignment in a direction perpendicular to the substrate surface.

The optical path converter 51 may be, for example, a grating coupler or a mirror. In addition, the direction of conversion may be the upper surface side (the side on which the optical amplifier 21 and the like are installed) or the back surface side (the side on which the optical amplifier 21 and the like are not installed) with respect to the substrate surface.

The integrated optical device 50 having such a configuration is configured to output the signal light for alignment branched by the connection tap port 31 in a direction perpendicular to the substrate surface. Therefore, since the measuring instrument and the optical fiber for monitoring the output signal light and the fixing jig do not geometrically interfere with each other, alignment can be performed more easily.

For the integrated optical device 50 as described above, by performing alignment while monitoring the signal light branched by the connection tap port 31, verification for evaluating the accuracy and simplicity of alignment was performed. In this verification, alignment according to the conventional technology, which is performed while monitoring the signal light output via the optical amplifier 21, was also performed, and comparative evaluation was performed. Here, the optical amplifier 21 is not operated. Note that the input light is signal light having a wavelength of 1.55 μm, which is typical in optical communication, and the optical amplifier 21 employs an SOA.

As a result of this verification, in the alignment according to the conventional technology, the intensity of the signal light decreases due to the optical loss in the SOA, and the intensity of the signal light is buried in the leakage light intensity generated by the mode field mismatch of the connection portion. Therefore, signal light and leakage light used for alignment cannot be distinguished, and alignment is difficult. On the other hand, it has been recognized that, in the integrated optical device 50 according to the present disclosure, such an optical loss does not occur, and signal light having sufficient intensity to perform highly accurate alignment can be monitored.

In the integrated optical device 50, the effect of compensating for the signal light by the operation of the optical amplifier 21 was also verified. In the verification, signal light having a wavelength of 1.55 μm and a light intensity of 0 dBm was input to the optical circuit element 11 to the directly connected integrated optical device 50, and the intensity of the signal light output via the optical function element 12 and the optical amplifier 21 was evaluated. At this time, the optical amplifier 21 was operated by applying a current of 300 mA. In addition, for comparison, an integrated optical device not including the optical amplifier 21 was also prepared, and intensity evaluation of output light was similarly performed. Here, the SOA is also applied to the optical amplifier 21.

As a result of this verification, in the integrated optical device not equipped with the SOA, while the intensity of the output light was −18 dBm, in the integrated optical device 50, the intensity of the output light was −6 dBm, which was higher than that of the integrated optical device not equipped with the SOA. That is, it has been recognized that the integrated optical device 50 according to the present disclosure is an integrated optical device in which different materials are directly bonded, but an optical loss due to a difference in refractive index and shape is compensated for, and signal light having high intensity can be output.

Note that the target of the above verification is the integrated optical device 50, but a similar effect is obtained even when the integrated optical device 30 shown in FIG. 3 is a target.

As described above, the integrated optical device (for example, the integrated optical device 30 or the integrated optical device 50) according to the present disclosure is configured to be able to perform alignment while monitoring the signal light by the connection tap port 31 without passing through the optical amplifier 21. By monitoring a part of the signal light branched by the connection tap port 31, it is possible to suppress an optical loss caused by the optical amplifier 21 and a complicated work at the time of alignment and to easily perform alignment of the connection portion with high accuracy.

### INDUSTRIAL APPLICABILITY

The integrated optical device according to the present disclosure is an integrated optical device by direct connection which is advantageous for size reduction, and it is possible to easily perform alignment of connection portions with high accuracy as compared with the conventional technology. Therefore, application to an optical fiber transmission device having an increased communication capacity is expected.

1. An optical circuit element directly connected to an optical function element, the optical circuit element comprising:
an optical amplifier that amplifies signal light input through a connection portion with the optical function element; and
a connection tap port that is installed between the optical amplifier and the connection portion, branches a part of the signal light input through the connection portion, and outputs the signal light to the outside, wherein
the connection tap port includes
an input port to which the signal light is input through the connection portion,
a demultiplexer that branches a part of the signal light,
a first output port that outputs the branched part of the signal light to the outside, and
a second output port that outputs the rest of the signal light to the optical amplifier.

2. The optical circuit element according to claim 1, wherein
the optical circuit element is a quartz-based planar lightwave circuit (PLC) installed on a Si substrate, or an optical circuit using silicon photonics (SiP), and
the optical amplifier is installed on a substrate using an indium phosphide (InP) based material.

3. The optical circuit element according to claim 1, further comprising:
an optical path converter that converts a part of the branched optical path of the signal light output from the first output port in a direction perpendicular to a substrate surface, wherein
the optical path converter is a grating mirror or a mirror.

4. An integrated optical device, wherein the optical circuit element according to claim 1 and the optical function element are directly connected.

5. A method for manufacturing the integrated optical device according to claim 4, the method comprising:
preparing the optical circuit element and the optical function element;
fixing the optical function element;
adjusting an end surface of a waveguide of the optical circuit element and an end surface of a waveguide of the optical function element to be parallel to each other;
aligning while monitoring a branched part of the signal light output from the first output port; and
connecting the optical circuit element and the optical function element.

6. The optical circuit element according to claim 2, further comprising:
an optical path converter that converts a part of the branched optical path of the signal light output from the first output port in a direction perpendicular to a substrate surface, wherein
the optical path converter is a grating mirror or a mirror.

7. An integrated optical device, wherein the optical circuit element according to claim 2 and the optical function element are directly connected.

8. An integrated optical device, wherein the optical circuit element according to claim 3 and the optical function element are directly connected.
